(19) United States
(12) Patent Application Publication
(10) Pub. No.: US 2020/0175569 A1
(43) Pub. Date: Jun. 4, 2020

(54) ORDERING SYSTEM AND PROGRAM

(71) Applicant: KOBAYASHI MANUFACTURE CO., LTD., Hakusan-shi, Ishikawa (JP)

(72) Inventor: Yasunori KOBAYASHI, Hakusan-shi (JP)

(73) Assignee: KOBAYASHI MANUFACTURE CO., LTD., Hakusan-shi, Ishikawa (JP)

(21) Appl. No.: 16/621,034

(22) PCT Filed: Jun. 15, 2018
(86) PCT No.: PCT/JP2018/022861

§ 371 Date: Dec. 10, 2019

(30) Foreign Application Priority Data
Jun. 15, 2017 (JP) 2017-118081

(51) Int. Cl. G06Q 30/06; B65G 61/00

(52) U.S. Cl. CPC G06Q 30/0635; B65G 61/00; G06Q 30/0641

(57) ABSTRACT

An orderer of a made-to-order product accesses an ordering system, using a terminal device, and displays, on the terminal device, a user interface for displaying the progress of manufacture of the ordered product. The user interface shows the order of the processes through which the product is manufactured, the current status of each process, the scheduled completion date of a process that has not been completed, etc. The orderer clicks on a mark corresponding to any of the processes with a right mouse button, an “image” button pops up. Upon the orderer clicking on the “image” button, an image capturing the state of the product in the process selected beforehand by clicking thereon with the right mouse button is displayed. By operating buttons and a slide bar displayed in the user interface, the orderer can display an image of the product captured at a desired time, on the terminal device.

### TECHNICAL FIELD

The present invention relates to technique for aiding in product ordering.

### BACKGROUND ART

There is a proposal of a mechanism that makes it possible to check how work was performed in the past, by storing images that capture how work was performed, and reading out and displaying the images when necessary. For example, in the mechanism disclosed in Patent Literature 1 according to an application filed by the applicant of the present application, images captured by imaging devices provided in each work site are stored, and upon a user specifying a progress display field from among a plurality of progress display fields that are displayed on a display device, an image corresponding to the specified progress display field is displayed on the display device.

### CITATION LIST

### Patent Literature

Patent Literature 1: JP 5416322B2

### SUMMARY OF INVENTION

### Technical Problem

Generally, an orderer that has ordered a product from an order recipient that manufactures made-to-order products has no means to check whether or not the product is manufactured according to a request made by the orderer, until the orderer receives the finished product. Therefore, inconvenience may occur, e.g. an orderer may receive a product that does not meet the orderer's request.

The present invention aims to provide a means for enabling an orderer that has ordered a product from an order recipient that manufactures made-to-order products, to check whether or not the product is manufactured according to the orderer's request.

### Solution to Problem

The present invention provides an ordering system including: a receiving unit configured to receive data from an external device; a transmitting unit configured to transmit data to an external device; a storage unit configured to store data; and a generation unit configured to generate user interface data that indicates a user interface that is a screen configured to display information on a terminal device that is used by a user and receive data input by the user. The receiving unit receives order data that indicates the specifications, quantity, and delivery deadline of a product that is to be manufactured, from a terminal device that is used by an orderer, the storage unit stores the order data, the transmitting unit transmits the order data to a terminal device that is used by an order recipient, the receiving unit receives image data that indicates an image of the product that is being manufactured or that has been manufactured, from an image device, the storage unit stores the image data received by the receiving unit, in association with a process that corresponds to the image data from among a plurality of processes that are required to be performed to manufacture the product, the generation unit generates user interface data for displaying an image indicated by image data stored in association with a process specified by the orderer from among the plurality of processes, and the transmitting unit transmits user interface data for displaying the image on the terminal device that is used by the orderer. The receiving unit receives order data that indicates the specifications, quantity, and delivery deadline of a product that is to be manufactured, from a terminal device that is used by an orderer, the storage unit stores the order data, the transmitting unit transmits the order data to a terminal device that is used by an order recipient, the receiving unit receives image data that indicates an image of the product that is being manufactured or that has been manufactured, from an image device, the storage unit stores the image data received by the receiving unit, in association with a process that corresponds to the image data from among a plurality of processes that are required to be performed to manufacture the product, the generation unit generates user interface data for displaying an image indicated by image data stored in association with a process specified by the orderer from among the plurality of processes, and the transmitting unit transmits user interface data for displaying the image on the terminal device that is used by the orderer.

With the above-described ordering system, an orderer that has ordered a product from an order recipient that manufactures made-to-order products can easily check whether or not the product is manufactured according to the orderer's request.

In the above-described ordering system, the receiving unit may receive, from the terminal device that is used by the order recipient, manufacture schedule data indicating scheduled periods in which the processes that are required to be performed to manufacture the product are to be respectively carried out, the storage unit may store the manufacture schedule data, the generating unit may generate user interface data for displaying the periods indicated by the manufacture schedule data, and the transmitting unit may transmit user interface data for displaying the periods, to the terminal device that is used by the orderer.

With the above-described ordering system, the orderer can easily check the manufacture schedule of the ordered product.

In the above-described ordering system, the receiving unit may receive, from the terminal device that is used by the order recipient, estimated expense data indicating the estimated expense involved in manufacture of the product, and the transmitting unit may transmit the estimated expense data to the terminal device that is used by the orderer.

With the above-described ordering system, the order recipient can easily provide the orderer with the estimated expense required to manufacture the product, and the orderer can determine whether or not to place an order considering the estimated expense provided by the order recipient.

In the above-described ordering system, the receiving unit may receive, from the terminal device that is used by the orderer, request data indicating a request regarding a process selected from among the plurality of processes, the transmitting unit may transmit the request data to the terminal device that is used by the order recipient, the receiving unit may receive, from the terminal device that is used by the orderer, response data that indicates a response to the request indicated by the request, and the transmitting unit may transmit the response data to the terminal device that is used by the orderer.

With the above-described ordering system, the orderer can easily make a request regarding any of a plurality of processes that are required to be performed to manufacture a product, and the order recipient can easily respond to the request received from the orderer. Therefore, regarding ordering using the ordering system, it is possible to alleviate the problem in that the orderer's request is not easily communicated to the worker who is in charge of the process.

In the above-described ordering system, the order recipient may include a plurality of workers, the receiving unit may receive, from the terminal device that is used by the order recipient, worker identification data that identifies workers who are respectively in charge of the plurality of processes, the storage unit may store the worker identification data, and the transmitting unit may transmit the response data to a terminal device that is used by a worker who is in charge of the process for which the request has been made and is identified by the worker identification data from among the plurality of workers.

With the above-described ordering system, the orderer can communicate a request directly to the worker of the order recipient who is in charge of the process for which the request is made.

The present invention also provides a program for causing a computer to function as the receiving unit, the transmitting unit, the storage unit, and the generating unit that are included in the above-described ordering system.

With the above-described program, it is possible to realize the above-described ordering system, using a computer.

### Advantageous Effects of Invention

According to the present invention, an orderer that has ordered a product from an order recipient that manufactures made-to-order products can easily check whether or not the product is manufactured according to the orderer's request.

### BRIEF DESCRIPTION OF DRAWINGS

FIG. 1 is a diagram showing an ordering system according to one embodiment and devices that perform data communication with the ordering system.

FIG. 2 is a diagram showing a configuration of a computer that is used to realize the ordering system according to one embodiment.

FIG. 3 is a diagram showing a configuration of the ordering system according to one embodiment.

FIG. 4 is a diagram illustrating a structure of data that is to be stored in the ordering system according to one embodiment.

FIG. 5A is a diagram illustrating a structure of data that is to be stored in the ordering system according to one embodiment.

FIG. 5B is a diagram illustrating a structure of data that is to be stored in the ordering system according to one embodiment.

FIG. 6 is a diagram illustrating a structure of data that is to be stored in the ordering system according to one embodiment.

FIG. 7 is a diagram showing a sequence of processing that is performed by the ordering system according to one embodiment and devices that perform data communication with the ordering system.

FIG. 8 is a diagram showing a user interface that is to be displayed on a terminal device that accesses the ordering system according to one embodiment.

FIG. 9 is a diagram showing a sequence of processing that is performed by the ordering system according to one embodiment and devices that perform data communication with the ordering system.

FIG. 10 is a diagram showing a user interface that is to be displayed on a terminal device that accesses the ordering system according to one embodiment.

FIG. 11 is a diagram showing a user interface that is to be displayed on a terminal device that accesses the ordering system according to one embodiment.

FIG. 12 is a diagram showing a sequence of processing that is performed by the ordering system according to one embodiment and devices that perform data communication with the ordering system.

FIG. 13 is a diagram showing a user interface that is to be displayed on a terminal device that accesses the ordering system according to one embodiment.

### DESCRIPTION OF EMBODIMENTS

The following describes ordering system 1 according to one embodiment of the present invention. FIG. 1 is a diagram showing ordering system 1 and devices that perform data communication with ordering system 1. In the example shown in FIG. 1, ordering system 1 is constituted by a server device. However, ordering system 1 may be constituted by a plurality of devices that operate in conjunction with each other.

Devices that perform data communication with ordering system 1 include terminal device 2 that is used by an orderer, terminal devices 3 and 4 that are used by an order recipient, and imaging device 5 that captures images showing the situation in which a product is manufactured. Terminal device 3 is used by an order recipient to input an estimated expense to the orderer, involved in manufacture of a product, a response to a request from the orderer, and so on. Terminal device 4 is a portable terminal with a built-in imaging device, and is used by the order recipient to capture images of a product when commencing and completing each of a plurality of processes that need to be performed to manufacture the product.

In the present application, the orderer and the order recipient are each not limited to being one person, and may be a plurality of persons belonging to a corporation, for example. Also, the orderer need not always use the same device as terminal device 2. Similarly, the order recipient need not always use the same devices as terminal devices 3 and 4.

Imaging device 5 is a network camera that is provided in the space where the order recipient manufactures a product, and captures images in the space.

Imaging device 5 is not limited to being one device. In the present embodiment, imaging device 5 constantly takes still images at predetermined intervals (e.g. one minute) regardless of whether or not work is performed to manufacture a product. Imaging device 5 transmits image data that indicates captured images to ordering system 1. Note that each piece of image data is accompanied with data indicating the shooting time thereof. Ordering system 1 stores image data received from imaging device 5.

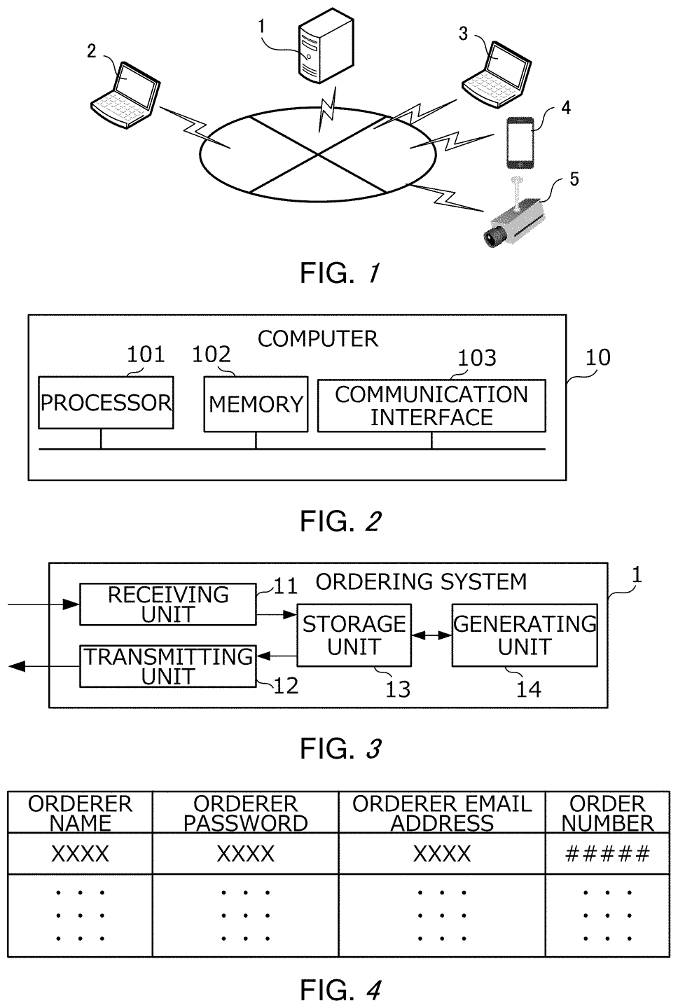

In the present embodiment, ordering system 1 is realized by a processor of a computer performing data processing that is executed in accordance with a program. That is to say, hardware that realizes ordering system 1 is a computer. FIG. 2 is a diagram showing a configuration of computer 10 that is used to realize ordering system 1. Computer 10 includes processor 101 that performs various kinds of data processing, memory 102 that stores various kinds of data, and communication interface 103 that receives and transmits various kinds of data from and to an external device.

Processor 101 performs data processing that is executed in accordance with a program according to the present embodiment, which is stored in memory 102, ordering system 1 that has the configuration shown in FIG. 3 is realized. That is to say, the program according to the present embodiment causes computer 10 to include receiving unit 11 that receives data from an external device, transmitting unit 12 that transmits data to an external device, storage unit 13 that stores data, and generation unit 14 that generates user interface data that indicates a user interface. A user interface is a screen that displays information from terminal device 2 and receives data input from the orderer, or a screen that displays information from terminal device 3 or terminal device 4 and receives data input from the order recipient.

Receiving unit 11 and transmitting unit 12 are realized by communication interface 103 that operates under the control of processor 101. Storage unit 13 is realized by memory 102 that operates under the control of processor 101. Generation unit 14 is realized by processor 101.

Storage unit 13 stores an orderer table that stores data regarding orderers (hereinafter referred to as “orderer data”), an order table that stores data regarding orders (hereinafter referred to as “order data”, and a correspondence table that stores data regarding requests from orderers to the order recipient and responses from the order recipient to the requests (hereinafter referred to as “correspondence data”).

FIG. 4 is a diagram illustrating a data structure of the orderer table. The orderer table illustrated in FIG. 4 stores, for each of a plurality of orderers, an orderer name that identifies the orderer, a password that is used to confirm the identification of the orderer (hereinafter referred to as “an orderer password”), an email address of the orderer, and an order number that identifies a product for which the orderer made a request for an expense estimate, or placed an order. Note that the order number that is to be associated with one orderer name is not limited to being one order number.

FIG. 5A and 5B are diagrams illustrating a data structure of the order table. FIG. 5B is a diagram showing details of the structure of data stored in the field of “process number 1”, the field of “process number 2”, and so on shown in FIG. 5A.

The order table illustrated in FIGS. 5A and 5B stores order numbers, order information such as orderer names, the name of an administrator of the order recipient, who is in charge of estimates and so on, an email address of the administrator, and information regarding each of a plurality of processes that are required to be performed to manufacture a product.

Information regarding each of the plurality of processes includes the content of work that is performed in the process, the name of the worker of the order recipient who is in charge of work, an email address of the worker, a scheduled commencement date, a scheduled completion date, a commencement date, a completion date, a status, and the period of time for which work has been performed.

FIG. 6 is a diagram illustrating a data structure of the correspondence table. The correspondence table illustrated in FIG. 6 stores an order number, a request ID (identifier) for identifying a request, a process number for identifying a process, the time at which the request was made (hereinafter referred to as “the request time”), the content of the request, the time at which a response to the request was made (hereinafter referred to as “the response time”), and the content of the response.

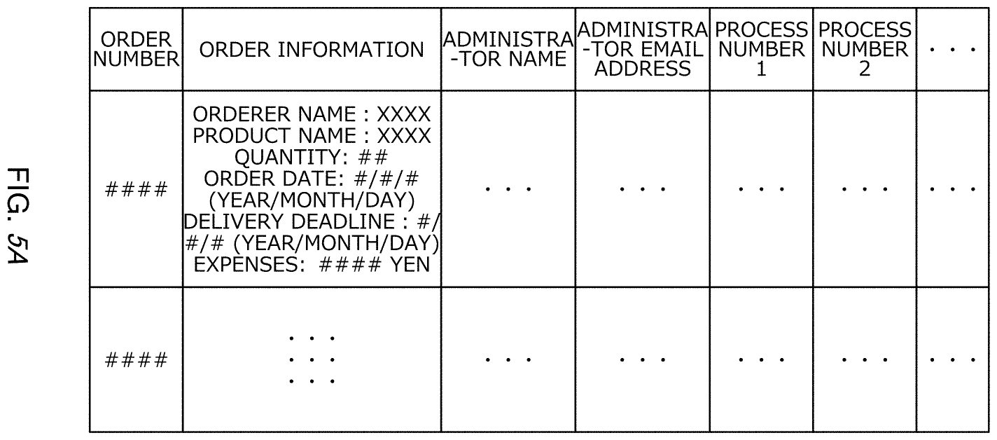

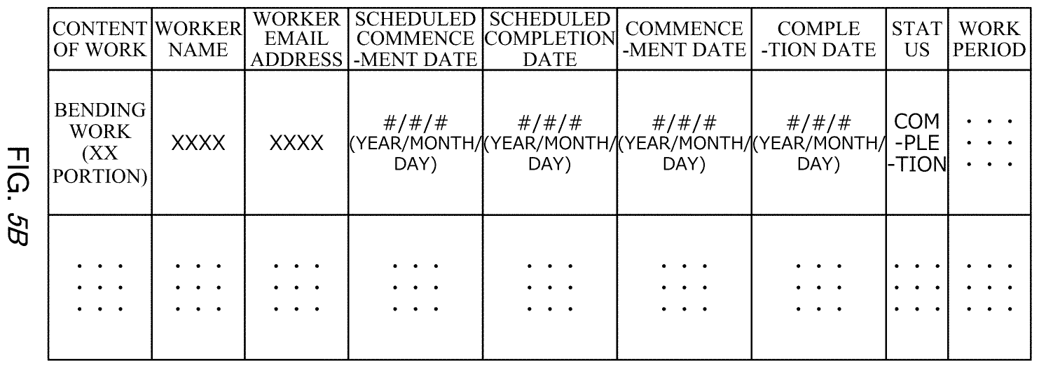

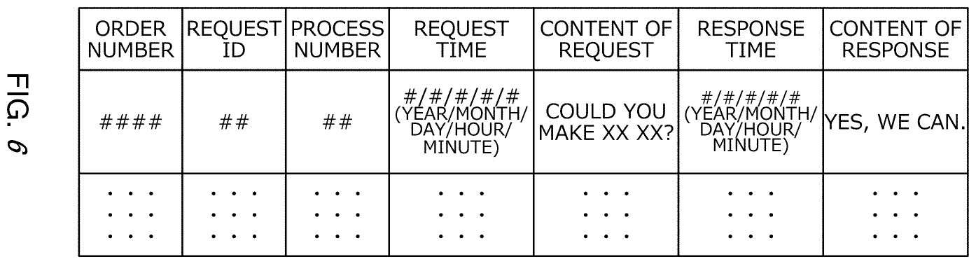

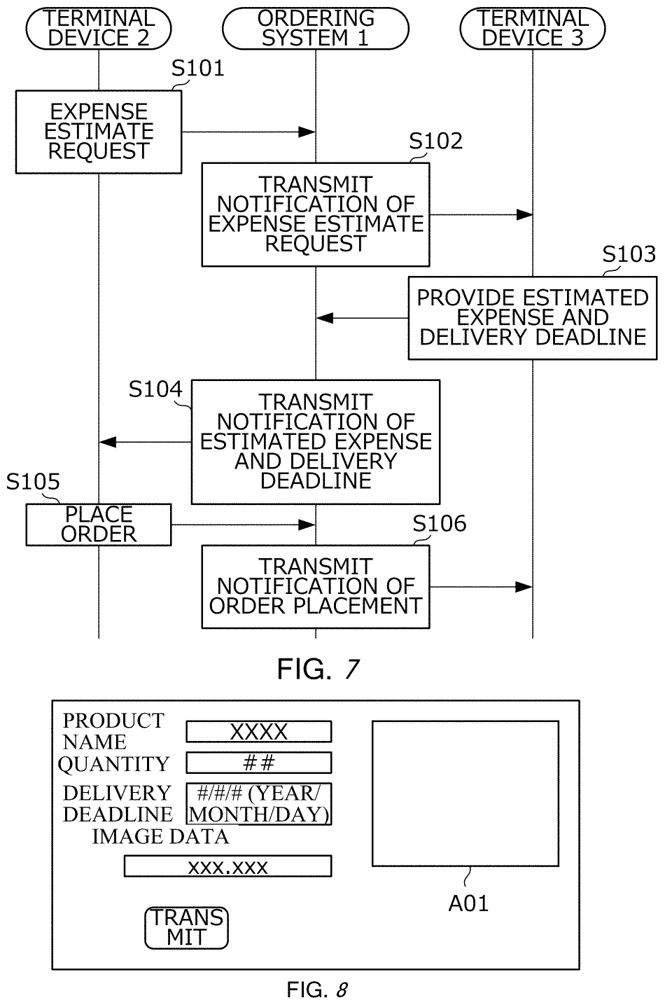

The following describes operations of ordering system 1. FIG. 7 is a diagram showing a sequence of processing that is performed by ordering system 1, terminal device 2, and terminal device 3 in the phase where an order to manufacture a product is placed and received. Note that, in the sequences shown in FIGS. 7, 9, and 12, log-in processing that is usually performed when terminal device 2, terminal device 3, and terminal device 4 access ordering system 1, processing through which ordering system 1 generates and transmits, to an orderer or an order recipient, user interface data indicating an user interface that is to be provided thereto, and processing through which ordering system 1 updates tables such as the order table (FIGS. 5A and 5B) and the correspondence table (FIG. 6), are omitted.

First, an orderer accesses ordering system 1, using terminal device 2, to make an expense estimate request (step S101).

FIG. 8 is a diagram showing a user interface that is displayed on terminal device 2 in step S101. The orderer inputs the product name, quantity, and delivery deadline of the product for which the orderer is considering making a request to manufacture, from the interface shown in FIG. 8.

The orderer also inputs the file name of a drawing that shows the specifications or the like of the product. In response to the file name being input, area A01 in the user interface shows an image that has the file name input by the orderer. Thereafter, the orderer clicks on the “transmit” button, using a mouse, for example. In response to this operation, expense estimate request data is transmitted from terminal device 2 to ordering system 1, the expense estimate request data including the product name, quantity, and delivery deadline of the product and the drawing showing the specifications or the like of the product. Ordering system 1 updates the order table (FIGS. 5A and 5B) based on the expense estimate request data received from terminal device 2. Note that the expense estimate request data stored in the order data is to be used when an order is thereafter made, as order data that shows the content of the order.

Subsequently, ordering system 1 notifies terminal device 3 of the fact that the expense estimate request has been made (step S102). This notification is transmitted to the email address of the administrator of the orderer via e-mail, for example.

The administrator who has received the notification regarding the expense estimate request estimates the expenses. Also, if it is impossible to meet the delivery deadline desired by the orderer, the administrator specifies a new delivery date that is feasible. The administrator accesses ordering system 1, using terminal device 3, to provide the estimated expense and the delivery deadline (step S103). At this time, the date transmitted from terminal device 3 to ordering system 1 serves as estimated expense data indicating the estimated expense. Ordering system 1 updates the order table (FIGS. 5A and 5B) based on the information received from terminal device 3.

Subsequently, ordering system 1 notifies terminal device 2 of the estimated expense and the delivery deadline provided from terminal device 3 (step S104). This notification is transmitted to the email address of the orderer via e-mail, for example.

The orderer provided with the estimated expense and the delivery deadline determines whether or not to place an order for the product. If the orderer decides to place an order, the orderer accesses ordering system 1, using terminal device 2, to place an order (step S105). Ordering system 1 updates the order table (FIGS. 5A and 5B) based on the information received from terminal device 2.

If an order has been placed, ordering system 1 notifies terminal device 3 of the fact that an order has been placed (step S106). This notification is transmitted to the email address of the administrator of the orderer via e-mail, for example.

Upon receiving the notification indicating that an order has been placed, the order recipient specifies a plurality of processes that are required to be performed to manufacture the ordered product, and determines scheduled periods in which the specified processes are to be respectively carried out (e.g. scheduled commencement dates and scheduled completion dates), and workers who are to respectively carry out the processes. The order recipient accesses ordering system 1, using terminal device 3, to input the pieces of data thus determined. The pieces of data input by the order recipient (including manufacture schedule data indicating the scheduled periods in which the processes are to be respectively carried out, and worker identification data identifying the workers who are respectively in charge of the processes) are transmitted from terminal device 3 to ordering system 1. Ordering system 1 stores the data received from terminal device 3, to the order table (FIGS. 5A and 5B).

When starting work to manufacture the ordered product, each worker of the order recipient accesses ordering system 1, using terminal device 3, to notify ordering system 1 of the fact that work has been started. This notification includes the process number of the work process that is to be performed, and data distinguishing between the start of a new work process (i.e. commencement) and the resumption of a work process that is in progress. Ordering system 1 updates the order table (FIGS. 5A and 5B) based on the information received from terminal device 3.

When ending work, each worker accesses ordering system 1, using terminal device 3, to notify ordering system 1 of the fact that work has been ended. This notification includes the process number of the process that has been ended, and data distinguishing between the end of the entire work process (i.e. completion) and a pause in the work process that has not been completed. Ordering system 1 updates the order table (FIGS. 5A and 5B) based on the information received from terminal device 3.

Also, when a worker commences a new work process, and when a worker has completed the entire work process, the worker accesses ordering system 1, using terminal device 4, and thereafter captures an image of the product, using terminal device 4. Terminal device 4 transmits image data that indicates the captured image to ordering system 1. Ordering system 1 stores the image data received from terminal device 4.

While the ordered product is being manufactured, the orderer can check the progress of manufacture, and check, with reference to an image, how the product is being manufactured, by accessing ordering system 1, using terminal device 2.

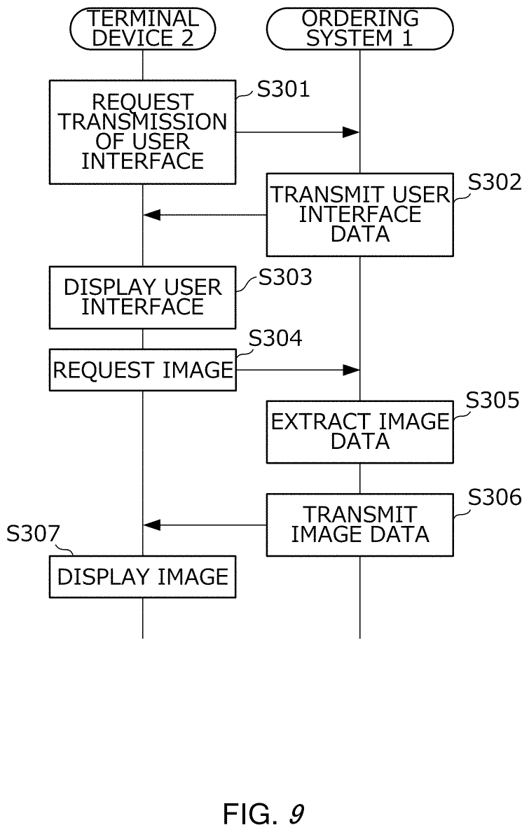

FIG. 9 is a diagram showing a sequence of processing that is performed by ordering system 1 and terminal device 2 when the orderer checks how the product is being manufactured with reference to an image. The orderer accesses ordering system 1, using terminal device 2, to request ordering system 1 to transmit a user interface that shows information regarding the progress of manufacture of the ordered product (step S301).

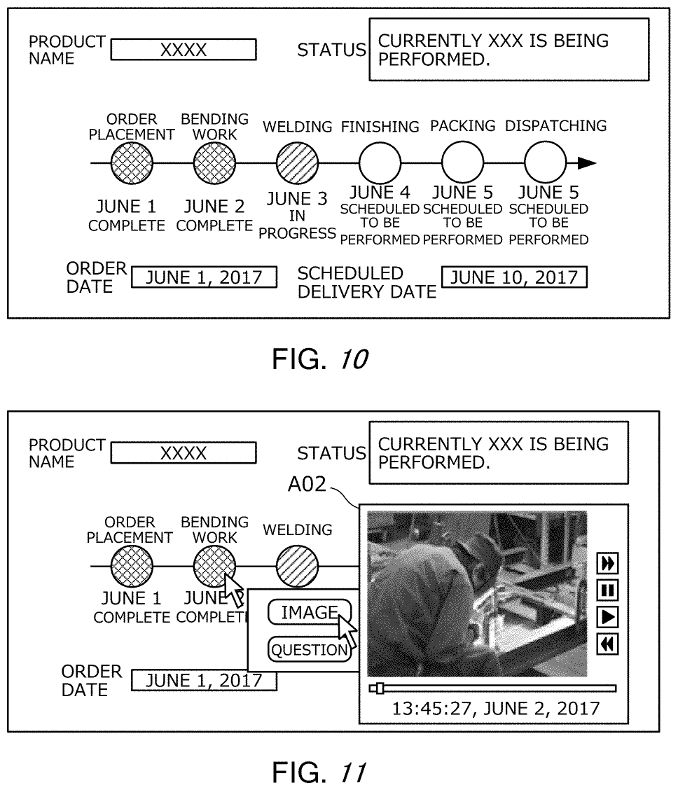

In response to this request, ordering system 1 generates user interface data for displaying progress information, and transmits it to terminal device 2 (step S302). As a result, terminal device 2 displays the user interface shown in FIG. 10 (hereinafter referred to as “the progress check interface”) (step S303). The progress check interface shows the order of the processes through which the product is manufactured, the current status of each process, the scheduled completion date of a process that has not been completed, and so on.

Upon the orderer clicking, with the right mouse button, for example, on a mark corresponding to any of the processes displayed on the progress check interface, an “image” button and a “request” button pop up as shown in FIG. 11. If the orderer clicks on the “image” button with a mouse, for example, a request for an image is transmitted from terminal device 2 to ordering system 1 (FIG. 9, step S304).

In response to the request from terminal device 2, ordering system 1 references the order table (FIGS. 5A and 5B) to specify the work period of the process specified by the request, and extracts image data that indicates an image that has been captured in the specified work period (step S305). Subsequently, ordering system 1 transmits the extracted image data to terminal device 2 (step S306). Terminal device 2 displays an image that is indicated by the image data transmitted from ordering system 1, in area A02 of the progress check interface (FIG. 11) (step S307). As a result, the orderer can check the state of the product that is in the process selected beforehand by clicking thereon with the right mouse button, with reference to the image. Note that the orderer can display an image captured at a desired time on terminal device 2 by clicking on various buttons displayed in area A02 with a mouse, for example, or dragging a slide bar displayed in area A02 with a mouse, for example.

Also, if the orderer has a request regarding any of the processes, the order can correspond with the order recipient via the progress check interface.

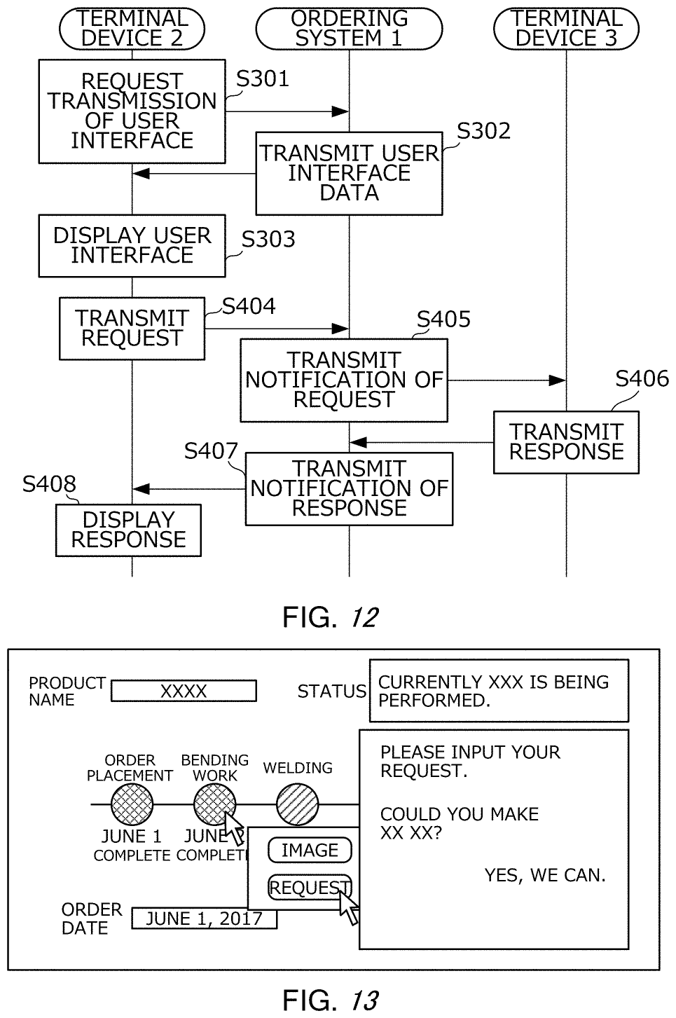

FIG. 12 is a diagram showing a sequence of processing that is performed by ordering system 1, terminal device 2, and terminal device 3 when the orderer corresponds with the order recipient. Steps S301 to S303 in FIG. 12 are the same as steps S301 to S303 in FIG. 9.

Upon the orderer clicking, with the right mouse button, for example, on a mark corresponding to any of the processes displayed on the progress check interface, the “image” button and the “request” button pop up as described above (FIG. 11). If the orderer clicks on the “request” button with a mouse, for example, a chat field pops up as shown in FIG. 13. If the orderer inputs, in the chart field, a request regarding the process selected beforehand by clicking thereon with the right mouse button, and clicking on the “transmit” button with the mouse, for example, request data that indicates the input request is transmitted from terminal device 2 to ordering system 1 (step S404). Ordering system 1 updates the correspondence table (FIG. 6) based on the information received from terminal device 2.

Ordering system 1 notifies terminal device 3 of the request received from terminal device 2 (step S405). This notification is transmitted to an email address of the worker who is in charge of the process for which the request has been made, via e-mail, for example. The worker accesses ordering system 1, using terminal device 3, to input a response to the request. Response data that indicates the response input to terminal device 3 is transmitted from terminal device 3 to ordering system 1 (step S406). Ordering system 1 updates the correspondence table (FIG. 6) based on the information received from terminal device 3.

Ordering system 1 notifies terminal device 2 of the response received from terminal device 3 (step S407). This notification is transmitted to the email address of the orderer via e-mail, for example. Also, the response of which terminal device 2 is notified is displayed in the chat field that pops up in the progress check interface, below the request corresponding thereto, for example (step S408).

With the above-described ordering system 1, the orderer can grasp the progress of manufacture of the ordered product. The orderer can check how the ordered product is manufactured, with reference to an image. The orderer can also exchange correspondence regarding a specific process of manufacture of the ordered product.

### Modifications

The above-described embodiment may be variously modified. Examples of such modifications are shown below. Note that two or more of the following modifications may be combined with each other.

(1) Data that ordering system 1 transmits directly to terminal device 2 or terminal device 3 that accesses ordering system 1 in the above-described embodiment may be transmitted in the form of an e-mail to terminal device 2 or terminal device 3 via a server device that stores e-mails.

(2) Data that terminal device 2 or terminal device 3 transmits directly to ordering system 1 by accessing ordering system 1 in the above-described embodiment may be transmitted in the form of an e-mail to ordering system 1 via a server device that stores e-mails.

(3) Terminal device 2 or terminal device 3 may execute a resident application program, and be always kept in the state of accessing ordering system 1. In this case, if data is transmitted from ordering system 1, terminal device 2 or terminal device 3 may notify the orderer or the order recipient of the reception of the data, using sound, for example.

(4) In the above-described embodiment, imaging device 5 and the image device included in terminal device 4 captures still images. However, images that are captured by these imaging devices are not limited to still images, and may be moving images. Also, if imaging device 5 captures moving images, imaging device 5 need not constantly capture moving images. For example, imaging device 5 may capture moving images with a predetermined duration (e.g. 30 seconds) at predetermined intervals (e.g. ten minutes).

(5) Images need not be captured by both imaging device 5 and terminal device 4. Images may be captured only by imaging device 5, and need not be captured by terminal device 4. Alternatively, images may be captured only by terminal device 4, and need not be captured by imaging device 5.

(6) In the above-described embodiment, when a process is commenced or complete, the order recipient inputs the fact using terminal device 3. However, instead, ordering system 1 may automatically store the commencement time in the order table upon image data obtained at the start of the process being transmitted from terminal device 4 to ordering system 1, and ordering system 1 may store the completion time in the order table upon image data obtained at the completion of the process being transmitted from terminal device 4 to ordering system 1.

(7) In the progress check interface, images that the orderer can view may be limited. For example, images captured at predetermined intervals (e.g. 30 minutes) may be extracted from among images stored in ordering system 1, and the orderer may be allowed to view only these extracted images.

(8) In the above-described embodiment, processes and images are associated with each other based on the periods in which the processes are executed and the times at which the images are captured. However, a method for associating processes and images is not limited to such a method. For example, if there is a process that is being executed when ordering system 1 receives image data from imaging device 5, the file name of the received image data may be associated with the process, and stored in the order table.

(9) The data showing the specifications of the product is not limited to data showing a drawing of the product. For example, if a product that is to be manufactured is a standard product that conforms to determined specifications, data indicating the standard identification number thereof may be used as data indicating the specifications.

(10) In the above-described embodiment, information regarding an uncompleted process is displayed in the progress check interface (FIG. 10).

However, information regarding an uncompleted process need not be displayed in the progress check interface.

(11) Ordering system 1 may manage ordering of manufacture of a product, performed between a plurality of orderers and a plurality of order recipients. If this is the case, an orderer may select a desired order recipient from among a plurality of order recipient candidates to order the order recipient to manufacture a product.

(12) Ordering system 1 may be realized using a dedicated device instead of a computer that performs data processing according to a program. Reference Signs List

1 . . . Ordering System, 2 . . . Terminal Device, 3 . . . Terminal Device, 4 . . . Terminal Device, 5 . . . Imaging Device, 10 . . . Computer, 11 . . . Receiving Unit, 12 . . . Transmitting Unit, 13 . . . Storage Unit, 14 . . . Generation Unit, 101 . . . Processor, 102 . . . Memory, 103 . . . Communication Interface

1. An ordering system comprising:
a receiving unit configured to receive data from an external device;
a transmitting unit configured to transmit data to an external device;
a storage unit configured to store data; and
a generation unit configured to generate user interface data that indicates a user interface that is a screen to display information on a terminal device that is used by a user and to receive data input by the user,
wherein the receiving unit receives order data that indicates specifications, quantity, and delivery deadline of a product that is to be manufactured, from a terminal device that is used by an orderer,
the storage unit stores the order data,
the transmitting unit transmits the order data to a terminal device that is used by an order recipient,
the receiving unit receives image data that indicates an image of the product that is being manufactured or that has been manufactured, from an image device,
the storage unit stores the image data received by the receiving unit, in association with a process that corresponds to the image data from among a plurality of processes that are required to be performed to manufacture the product,
the generation unit generates user interface data for displaying an image indicated by image data stored in association with a process specified by the orderer from among the plurality of processes,
the transmitting unit transmits user interface data for displaying the image on the terminal device that is used by the orderer,
the receiving unit receives, from the terminal device that is used by the orderer, request data indicating a request regarding a process selected from among the plurality of processes,
the transmitting unit transmits the request data to the terminal device that is used by the order recepient,
the receiving unit receives, from the terminal device that is used by the orderer, response data that indicates a response to the request indicated by ther request, and
the transmitting unit transmits the response data to the terminal device that is used by the orderer,
the genenation unit generates the user interface data that indicates a user interface that is a screen to display a button and an another button, the button being to show an image indicated by image data stored associated with the process specified by the orderer, the another button being to input a request relating to the specified process.

2. The ordering system according to claim 1,
wherein the receiving unit receives, from the terminal device that is used by the order recipient, manufacture schedule data indicating scheduled periods in which the processes that are required to be performed to manufacture the product are to be respectively carried out,
the storage unit stores the manufacture schedule data,
the generating unit generates user interface data for displaying the periods indicated by the manufacture schedule data, and
the transmitting unit transmits user interface data for displaying the periods, to the terminal device that is used by the orderer.

3. The ordering system according to claim 1,
wherein the receiving unit receives, from the terminal device that is used by the order recipient, estimated expense data indicating the estimated expense involved in manufacture of the product, and
the transmitting unit transmits the estimated expense data to the terminal device that is used by the orderer.

4. (canceled)

5. The ordering system according to claim 1,
wherein the order recipient includes a plurality of workers,
the receiving unit receives, from the terminal device that is used by the order recipient, worker identification data that identifies workers who are respectively in charge of the plurality of processes,
the storage unit stores the worker identification data, and
the transmitting unit transmits the response data to a terminal device that is used by a worker who is in charge of the process for which the request has been made and is identified by the worker identification data from among the plurality of workers.

6. A program for causing a computer to function as the receiving unit, the transmitting unit, the storage unit, and the generating unit that are included in the ordering system according to claim 1.

7. The ordering system according to claim 2,
wherein the receiving unit receives, from the terminal device that is used by the order recipient, estimated expense data indicating the estimated expense involved in manufacture of the product, and
the transmitting unit transmits the estimated expense data to the terminal device that is used by the orderer.

8. A program for causing a computer to function as the receiving unit, the transmitting unit, the storage unit, and the generating unit that are included in the ordering system according to claim 2.

9. A program for causing a computer to function as the receiving unit, the transmitting unit, the storage unit, and the generating unit that are included in the ordering system according to claim 3.

10. A program for causing a computer to function as the receiving unit, the transmitting unit, the storage unit, and the generating unit that are included in the ordering system according to claim 5.

11. A program for causing a computer to function as the receiving unit, the transmitting unit, the storage unit, and the generating unit that are included in the ordering system according to claim 7.
